(19) United States
(12) Patent Application Publication
(10) Pub. No.: US 2019/0121907 A1
(43) Pub. Date: Apr. 25, 2019

(54) GROUPING MESSAGES BASED ON TEMPORAL AND MULTI-FEATURE SIMILARITY

(71) Applicant: International Business Machines Corporation, Armonk, NY (US)

(72) Inventors: Jonathan F. Brunn, Logan, UT (US); Daniel Dulaney, Groton, MA (US); Ami Dewar, Durham, NC (US); Ethan A. Geyer, Mebane, NC (US); Bo Jiang, BEIJING (CN); Rachael Dickens, Raleigh, NC (US); Scott E. Chapman, LITTLETON, MA (US); Thomas Blanchflower, Raleigh, NC (US); Naama Tepper, HAIFA (IL)

(21) Appl. No.: 15/791,200

(22) Filed: Oct. 23, 2017

(51) Int. Cl. G06F 17/30; H04W 4/12

(52) U.S. Cl. CPC G06F 17/30707; H04W 4/12

(57) ABSTRACT

Message grouping using temporal and multi-factor similarity includes grouping multiple messages of a corpus in a group messaging system into a number of message bursts. Each message burst includes a number of messages that have a temporal relationship. Multiple of the number of message bursts are grouped into a message cluster. The grouping is based on a similarity of the number of message bursts as defined by multiple features of the message bursts.

### STATEMENT REGARDING PRIOR DISCLOSURES BY THE INVENTOR OR A JOINT INVENTOR

Aspects of the present invention may have been disclosed by the inventors in the presentation “IBM Watson Workspace & Work Services”, “Watson Work Services”, and “IBM Watson Workspace” presented to the public at IBM World of Watson Conference 2016 from Oct. 24-27, 2016. The following disclosure is submitted under 35 U.S.C. § 102(b)(1)(A).

### BACKGROUND

The present invention relates to electronic message grouping, and more specifically, to grouping electronic messages based on temporal and multi-feature similarity. In professional and social environments, users interact with one another using electronic text-based messages and other forms of electronic messages. Group messaging systems provide a platform for such electronic interaction. Examples of such group messaging systems include social networking systems, internal messaging systems, such as within an organization, and others. The use of these group messaging systems is increasing, and will continue to increase, with the expanding nature of electronic social interactions. That is, inter-user electronic interactions are becoming less and less tied to geographical boundaries and group messaging systems as a whole are becoming an increasingly relevant component of human correspondence.

### SUMMARY

According to an embodiment of the present specification, a computer-implemented method for grouping messages based on temporal and multi-feature similarity is described. According to the method multiple messages of a corpus in a group messaging system are grouped into a number of message bursts. Each message burst includes a number of messages that have a temporal relationship. Multiple of the number of message bursts are grouped into a message cluster. This grouping is based on a similarity of the number of message bursts as defined by multiple features of the message bursts.

The present specification also describes a system for grouping messages based on temporal and multi-feature similarity. The system includes a database to contain a corpus of messages for a group messaging system. A burst grouper groups multiple messages of a corpus in a group messaging system into a number of message bursts. Each message burst includes a number of messages that have a temporal relationship. A burst summarizer, determines a topic, or list of topics, for each of the number of message bursts. A cluster grouper groups multiple of the number of message bursts into a message cluster. The grouping of the message bursts into a message cluster is based on a similarity of the number of message bursts as defined by multiple features of the message bursts.

The present specification also describes a computer program product for grouping messages based on temporal and multi-feature similarity. The computer program product includes a computer readable storage medium having program instructions embodied therewith. The program instructions executable by a processor to cause the processor to group multiple messages of a corpus in a group messaging system into a number of message bursts. Each message burst includes a number of messages that have a temporal relationship. The program instructions executable by a processor to cause the processor to present the number of message bursts responsive to a first user action. The program instructions executable by a processor to cause the processor to determine a topic, or list of topics, for each of the number of message bursts. The program instructions executable by a processor to cause the processor to group multiple of the number of messages bursts into a message cluster. The grouping is based on a similarity of the number of message bursts as defined by multiple features of the message bursts. The number of message bursts include at least two message bursts that are disjointed in time. The program instructions executable by a processor to cause the processor to present a number of message clusters responsive to a second user action.

### BRIEF DESCRIPTION OF THE DRAWINGS

FIG. 1 depicts a flowchart of a method for grouping messages based on temporal and multi-feature similarity, according to an example of principles described herein.

FIG. 2 depicts a system for grouping messages based on temporal and multi-feature similarity, according to an example of the principles described herein.

FIG. 3 depicts various levels of message grouping based on temporal and multi-feature similarity, according to an example of the principles described herein.

FIG. 4 depicts a flowchart of a method for grouping messages based on temporal and multi-feature similarity, according to an example of principles described herein.

FIG. 5 depicts a system for grouping messages based on temporal and multi-feature similarity, according to an example of the principles described herein.

FIG. 6 depicts a graph of feature vector similarity, according to an example of the principles described herein.

FIG. 7 depicts a computer readable storage medium for grouping messages based on temporal and multi-feature similarity, according to an example of principles described herein.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As described above, electronic messaging within groups has become a form of day-to-day correspondence for many people. In some examples, relevant and important information is passed through these collaborative groups. For example, within an organization, a development team may be working to develop a new product. The development team may use the group messaging system to exchange ideas, make decisions regarding product design, supply-chain, and release dates for the product, and perform any type of collaborative work related to the product or other facets of their team. This information can then be relied on at a later point in time to review decisions that have been made, or simply to explore previous discussions about a particular topic. Users of such group messaging systems may belong to a number of different teams that use the group messaging system to discuss and correspond in regards to different topics. While such group messaging systems provide efficacy in electronic communication, some characteristics limit their more complete implementation.

For example, given that such large amounts of information can be passed in these group messaging scenarios, it may be difficult to retrace the conversation to find message threads related to a particular topic. For example, a user may desire to review correspondence related to a design choice for an upcoming product. In order to find that information, a user may have to scan the entire message corpus to identify those correspondence. If the user had discussed this design choice with different groups, i.e., managers in one group and manufacturers in another group, the user would have to scan the entire message corpus for both groups.

A user may be able to perform a text search, but this may just return results that include a specific phrase, and may not include conversations that are about that topic, but that do not specifically include the text searched for. In other words, a text search may not provide a complete picture of the messages that relate to the desired topic. Moreover, any grouping of the messages that can be done is generally chronological, and does not provide any sort of topical combining. Such chronological sorting may impede the discovery of new information and can keep a user focused on the present conversation in a way that blinds the user to context. Moreover, as topics can change rapidly, such chronological sorting can make it difficult to offer a single cohesive summary of activities and conversations over a period of time, including days or weeks.

Accordingly, the present specification describes a method and system that provide enhanced exploration within a corpus of messages. Such exploration may be to identify particular conversations, or discussion topics. That is, the method and system allow for topical exploration of a message corpus. Using the methods and systems described herein, a user can broaden or narrow a search or explore for information without knowing precise search terms, keywords, and can even perform such exploration without composing a search string.

Specifically, rather than navigating chronologically, the present specification summarizes small message bursts. A user may then “zoom out” not only based on chronological factors, but topical features as well. According to the method, a corpus of messages is grouped into message bursts, which refer to sequences of messages that are topically and temporally related. Each message burst can be summarized such that a topic, or list of topics, is determined for each message burst. Multiple bursts are then grouped into message clusters based on the similarity of the message bursts. For example, message bursts may be converted into a format where they can be compared to one another based on certain characteristics. If the message bursts have a predetermined level of similarity, they can be grouped into message clusters. Such grouping may be independent of time such that all message bursts that are related are grouped into a message cluster regardless of when the message bursts occur. This process can continue such that message clusters are compared and further grouped into second-degree message clusters. Accordingly, a user can continue to “zoom out” any number of times to identify conversations at a variety of degrees of generality. As such, a user can explore a corpus of messages topically, rather than just temporally, thus exposing the user to a more robust, and useful form of textual searching.

In summary, such a system and method 1) allow a user to gain contextual information about a topic, whether or not the user was there; 2) allow a user to view topical conversations in which they may not have participated, but are related to a topic of interest; 3) allow a user to understand a larger context of a given conversation, including related decisions already made and things learned; 4) group messages not only temporally, but topically; 5) provide efficient navigation of a corpus of messages based on topic; 6) provide viewing of information to any level of generality; and 7) provide a robust organization of conversation messages. However, it is contemplated that the devices disclosed herein may address other matters and deficiencies in a number of technical areas.

As used in the present specification and in the appended claims, the term “message burst” refers to a group of individual messages within a corpus from the group messaging system that are grouped together topically and temporally. A message burst may include any number of individual messages.

Further, as used in the present specification and in the appended claims, the term “message cluster” refers to groups of individual message bursts that are grouped together topically and temporally and based on other features. A message cluster may include any number of individual message bursts.

Still further, as used in the present specification and in the appended claims, the term “group messaging system” refers to any system wherein users send electronic messages and other messages to each other. Examples of such systems include social networking systems, instant messaging chats, electronic mail systems, and group collaboration systems as well as others.

Even further, as used in the present specification and in the appended claims, the term “a number of” or similar language is meant to be understood broadly as any positive number including 1 to infinity.

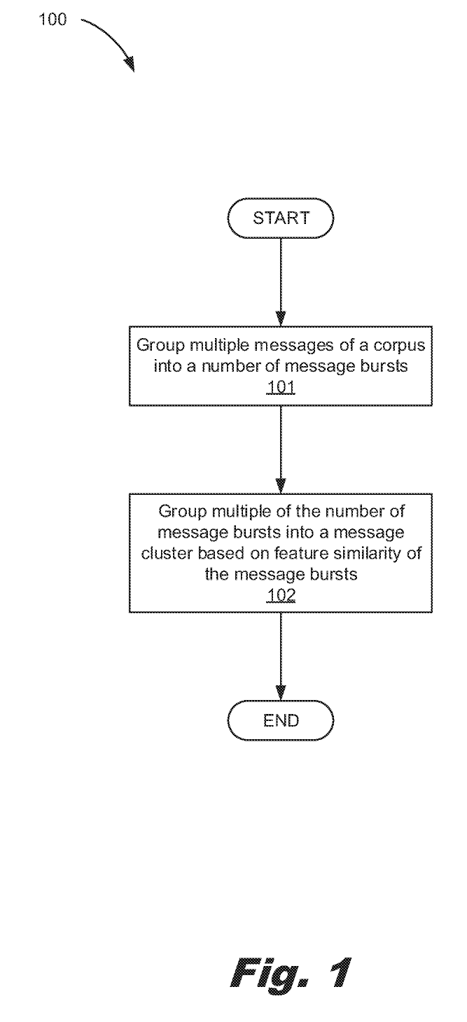

FIG. 1 depicts a flowchart of a method (100) for grouping messages based on temporal and multi-feature similarity, according to an example of principles described herein. According to the method (100), multiple messages of a corpus are grouped (block 101) into a number of message bursts. During a correspondence within a group messaging system, different users may input messages via text, audio, or video to be shared with other users of the system. Additional content such as documents, audio files, image files, video files, etc. may also be shared between users in these group messaging systems. The messages within a particular working group of the group messaging system may be sent over hours, days, or even weeks. Groups of these messages can be grouped (block 101) into message bursts based on at least a temporal relationship. Accordingly, each message burst includes a number of messages that have at least a temporal relationship. In grouping (block 101) messages into message bursts, an interaction on a particular topic at a particular time is captured.

The messages in the corpus that are to be grouped into message bursts will be the same for all users within a particular conversation. Accordingly, in some examples, grouping (block 101) of the messages to message bursts may occur as messages arrive. In another example, the grouping (block 101) occurs periodically, for example after a predetermined period of time or after a predetermined number of messages have been received

Such grouping (block 101) may be based on any number of factors. For example, the messages may be grouped (block 101) based on an inter-message interval time. That is, messages that have shorter inter-message intervals are more likely to relate to the same topic. Accordingly, a threshold inter-message interval time may be selected and adjacent messages that have an inter-message interval that is less than the threshold may be grouped into a message burst. If adjacent messages have an inter-message interval that is greater than the threshold value, the former message may be placed in a first message burst and the latter message may be grouped in a second message burst. The inter-message interval threshold may depend on the activity within the conversation. For example, in an active conversation, the inter-message interval threshold may be 5 minutes whereas a less active conversation may have an inter-message interval threshold of 1 hour. In this example, a single pass operation may be implemented meaning that each message is analyzed one time, as it comes in. For example, as a message comes in, the difference in arrival between that message and the preceding message may be analyzed one time to determine if it is greater than, or less than, the threshold value.

Such grouping (block 101) may be based on additional factors as well. For example, natural language processing of valediction and salutation as well as connecting phrases may be used to determine which message burst a message should be grouped to. For example, the word “hello” in a message is suggestive that a new message burst should be created, and the word “goodbye” is suggestive that a message burst should be closed. Moreover, other linking words could be used to determine a continuation of a message burst. For example, the phrase “that's a good idea,” indicates that a message should be joined in a message cluster with a previous message. In one example, such grouping based on natural language analysis of valediction, salutation, and connecting words may be implemented in conjunction with an inter-message interval. For example, if two messages have an inter-message interval greater than the threshold value, those messages can be analyzed via a natural language processor to determine if either includes a valediction, salutation, or connecting phrase that would aid in determining whether those adjacent messages should be part of the same message burst.

In another example, a topical analysis may be performed. For example, a textual analysis may be carried out on the messages as they arrive and adjacent messages that are determined to have the same topic may be joined to the same message burst. For example, Latent Dirichlet Allocation (LDA) could be used to discover topics from messages. Such a system may analyze multiple messages to determine whether those messages relate to the same topic or not. In one example, topics are calculated for individual messages, and/or for some number of trailing messages which are candidates for inclusion in a particular burst. These topics are then compared to determine if the topic has changed such that a particular message burst should be ended and a new one begun.

As with the natural language processing, such a topical analysis could be implemented in conjunction with either, or both, of inter-message intervals and natural language processing. For example, inter-message interval, degree of topic change, and a confidence in salutation or valediction are all quantified and can be combined through a number of formulas applying varying weights to each to produce a single score which is ultimately treated as a confidence. A threshold can be applied to the confidence to make a binary decision of joining a message or set of messages into the current message burst or creating a new message burst. In summary, in this operation, multiple messages of a corpus are grouped (block 101) into a message burst using any number of grouping criteria.

Groups of multiple message bursts are then grouped (block 102) into message clusters. That is, each message cluster includes a number of message bursts. The grouping (block 102) of message bursts into message clusters may be based on feature similarity between the message bursts. While the messages are grouped into message bursts based on temporal relationship, i.e. they are sequential messages within a conversation, the message bursts in a message cluster may be disjointed in time. For example, message bursts that occur at different times may be related to one another based on certain features. These disjointed message bursts can be grouped together in a single message cluster. As an example, a first message burst may relate to a product design, a second message burst immediately following the first may switch topics to discuss productivity of a team associated with the product, and a third message burst immediately following the second may return to talking about the product design. In this example, the first and third message bursts, although separated in time, may be joined in a single cluster due to the relatedness of their topic and the second message burst may be grouped with other message bursts related to the productivity of the team.

In grouping message bursts into message clusters, there may be a similarity threshold which sets a metric as to whether message bursts are to be grouped into a similar message cluster. This similarity threshold may be determined empirically and may be adjusted based on user feedback indicating whether particular message bursts were correctly grouped.

There may be many features on which a similarity of different message bursts may be determined. For example, a topic can be determined for each message burst. That is, each message burst may be summarized, and a topic generated for that message burst. This may be done using any number of message summarization techniques. For example, a key message may be identified, and that message classified as the topic. In another example, extraneous terms may be removed from the key message, or a few messages and the messages with extraneous terms removed may be classified as the topic for that message burst. Message bursts with similar topics may be grouped (block 102) into a particular message cluster

As another example, a degree of similarity may be based on the participants in each message burst. That is, message bursts that have more participants in common are more likely to be related to the same topic than message bursts having fewer participants in common. Another example is a level of participation of the user. As will be described in greater detail below, the clustering of message bursts may be unique to a user of the system. Accordingly, if the user operating the system, or another user, has large amounts of participation in different message bursts, it is more likely those message bursts relate to a particular topic and therefore should be grouped together as opposed to the user participating to a different degree in different message bursts. Yet another example is message proximity. For example, message bursts that are closer together in time are more likely to be grouped into a similar message cluster than are message bursts that are farther apart.

Another example of features used to group message bursts into message clusters is keywords found within the message bursts. As described above, a textual analysis can be carried out of the messages in a message burst to determine which words are keywords in the conversation. If these same keywords show up in messages of another message burst, it may be determined that they can be grouped together in a single message cluster. In yet another example, the topical summary of the message bursts may be used when grouping them into message clusters.

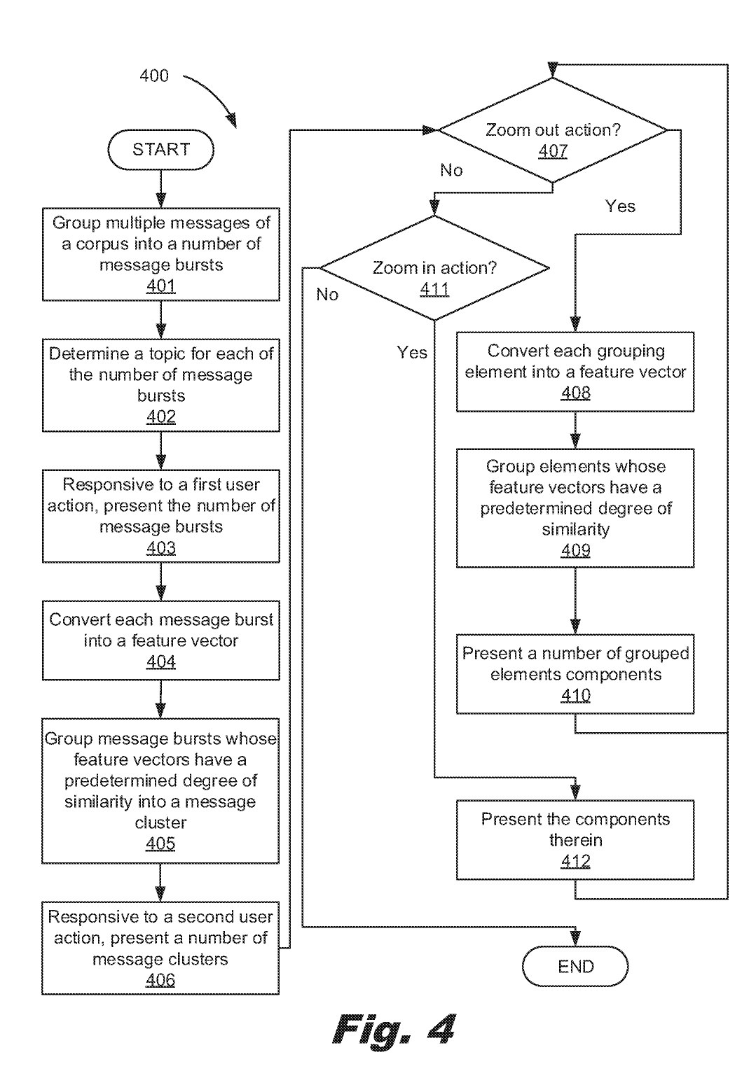

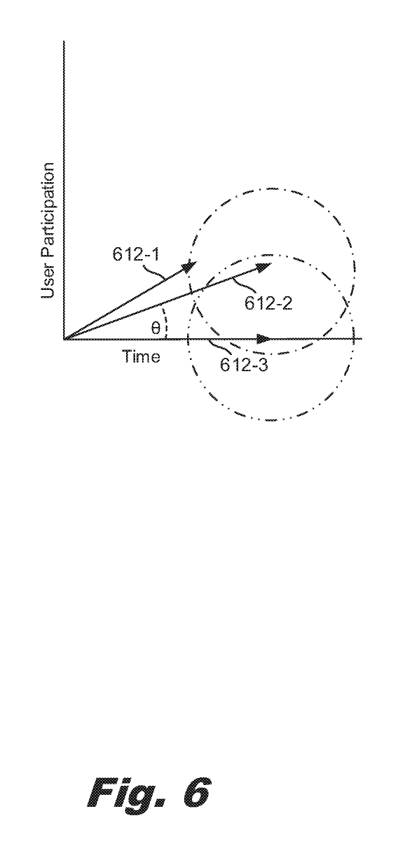

Note that while specific reference is made to particular features that are used to determine whether particular message bursts are similar enough to be grouped into message clusters, any number of features may be used to determine similarity of message bursts. Moreover, it should be noted that each of the above-mentioned features, and others, may be used in combination with one another to determine message burst similarity. A specific example of comparing message bursts based on feature similarity is provided below in connection with FIGS. 4 and 6.

In some examples, each of the different features may be weighted to determine message burst similarity. For example, participants in a message burst may be a more relevant factor in determining message burst similarity than is temporal proximity. The weightings given to a particular feature may be determined empirically. Additionally or alternatively, the weightings may be based on user behavior, group behavior and/or entity behavior. That is, if a particular user, group or entity feedback may indicate that a clustering of certain message bursts to be inaccurate for a particular reason, a feature relating to that reason may be weighted down. For example, during use, a user can approve or reject a particular grouping. Such approval or rejection can come in the form of gestures to remove a message burst from a message cluster for instance, or to add a message burst to another cluster. From these actions, when taken together across many interactions, a system can learn how much to weight different features.

In one specific example, the system treats the feature types (participant, topic, term, time) as themselves being features with respect to a space, channel or context in a model. These models may be defined per user, group or other entity (channel). When re-enforcing this model, the similarity or distance of the message burst that is removed from the message cluster is used as the value of the feature. For example, if a message burst is removed from a message cluster, and that message burst is temporally distant from the other message bursts in that message cluster or from another message burst that previously defined the message cluster, then the model is re-enforced by leaving a negative weight for message bursts which are temporally distant from each other.

In some examples, the composition of the message clusters, i.e., the message bursts that are within a message cluster, may be unique to a user. That is, while the message stream involves a set of messages which are the same for all users, personalization can occur while the message bursts are grouped into message clusters. For example, as described above, one particular feature on which message bursts are grouped into message clusters includes the level of participation of a user. Accordingly, if one user heavily participates in a first and third message burst, but not in a second, then the first message burst and third message burst may be grouped in a first message cluster for that user and the second message burst grouped in a second message cluster for that user. By comparison, a second user may heavily participate in the first and second message bursts, but not as much in the third message burst. Accordingly, for this user the first message cluster may include the first and second message bursts and a second message cluster may include the third message burst.

Such personalization may include adding features that are specific to the user, to the multiple features from which similarity between message bursts is determined. For instance, the feature list for a message burst may be augmented with features derived from meetings and other messages the user has related to the message burst or that are temporally co-incident with their participation in the message burst. For example, if the user sends an email or chat while also communicating in the message burst, the user's email and/or chat can augment the model for the message burst for that user and thereby aid in selection of additional message bursts to group. As a specific example, a user may have a side chat and may reference a development project by a code name. This additional code name can become part of the feature list for that message burst. That is, even though the original message stream itself may not have contained anything linking the set of messages to the development project, the user's email and/or chat message may enhance the feature of that message burst for that user, but not other users.

In another example, while participating in a message conversation that becomes a message burst, a user may send an email message to a user not participating in the conversation. Accordingly, the receiver of this email message may be added as a feature used to determine the similarity between the message burst and another message burst.

In one example, a relevance given to the degree of difference in participation can vary by user. That is, a user may view some groupings of conversations grouped more by user and others more by topic or time, regardless of their own participation. Accordingly, even if two users didn't participate in any of the message bursts, they might see different views.

By grouping message bursts into message clusters not only based on temporal similarity, but based on the similarity of multiple features of the message bursts, a more meaningful message exploration feature is provided that allows a user to start in one point in time in a conversation and zoom out to see related, but disjointed, messages together. Doing so provides exploration through different dimensions.

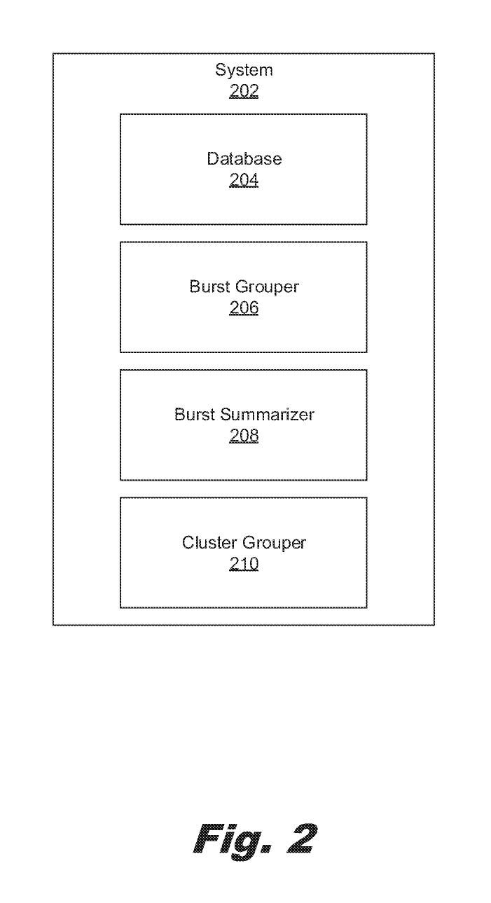

FIG. 2 depicts a system (202) for grouping messages based on temporal and multi-feature similarity, according to an example of the principles described herein. To achieve its desired functionality, the system (202) includes various components. Each component may include a combination of hardware and program instructions to perform a designated function. The components may be hardware. For example, the components may be implemented in the form of electronic circuitry (e.g., hardware). Each of the components may include a processor to execute the designated function of the engine. Each of the components may include its own processor, but one processor may be used by all the components. For example, each of the components may include a processor and memory. Alternatively, one processor may execute the designated function of each of the components.

The system includes a database (204). The database (204) includes a corpus of messages for a group messaging system. For example, the database (204) could include messages shared over a social networking system, an instant messaging system, an email system, or other group collaborative system, which other collaborative system may include features of the other systems. A burst grouper (206) of the system (202) groups multiple messages of a corpus into a number of message bursts. As described above, such grouping may be based on a variety of factors including inter-message intervals, natural language processing of valediction, salutation, connecting words or other textual components, and/or topical analysis. Accordingly, the messages that make up a message burst include at least a temporal relationship. In some examples, the messages that form a message burst may be from different conversations within the group messaging system.

A burst summarizer (208) of the system (202) determines a topic for each of the number of message bursts. That is, the burst summarizer (208) uses any variety of summarization techniques such as extraneous word extraction and keyword identification to summarize, and provide a topic for each of the message bursts. Based on the summaries and a number of other features, a cluster grouper (210) groups multiple message bursts into message clusters. As described above such grouping of message bursts into a message cluster is based on more than temporal similarity, but may also group message bursts based on topical similarity. Put another way, a message burst includes messages that have a temporal similarity and a message cluster comprises bursts that have a topical similarity and may be independent of a temporal similarity. In some examples, the message bursts that form a message cluster may be from different conversations within the group messaging system.

In some examples, the cluster grouper (210) groups multiple message clusters into a second-degree message cluster. This may be similar to how message bursts are grouped into message clusters. That is, each message cluster may be represented by a number of features, which features are combined and compared against other message clusters. Message clusters having a predetermined degree of similarity are grouped into second-degree message clusters. Accordingly, the system (202) allows for a number of hierarchical groupings of messages such that any level of generality can be obtained to classify messages within a corpus.

The features used to classify message bursts into message clusters may be the same or different than the features that are used to group message clusters into second-degree message clusters. Moreover, the weights applied to features when grouping message bursts into message clusters may be different than the weights applied to features when grouping message clusters into second-degree message clusters. That is, the features of the message bursts used to group multiple message bursts into message clusters may be weighted according to a first scheme- and the features of the message clusters that are used to group multiple message clusters into a second degree message cluster are weighted according to a second scheme and the first scheme may be different than the second scheme.

Moreover, the threshold by which message bursts are determined to be similar may be different than the threshold by which message clusters are determined to be similar. For example, the cluster grouper (210) may use a first similarity threshold to group multiple message bursts into a message cluster and may use a second similarity threshold to group multiple message clusters into a second-degree message cluster wherein the second similarity threshold is more inclusive than the first similarity threshold. Accordingly, at a message burst level, messages are grouped chronologically. At a message cluster level the bursts are grouped to a first level of generality, and at a second-degree cluster level, the clusters are grouped to a more general degree. For example, product research, product testing, product manufacturing, product advertising, and product consumer testing may be different message bursts. The product research, product testing, and product manufacturing message bursts may be grouped into a product development message cluster and the product advertising and product consumer testing may be grouped into a product market testing message cluster. The product development message cluster and the product market testing message cluster may be grouped into a product second-degree message cluster. Accordingly as can be seen, the second-degree message cluster is more general and includes at least as many messages as compared to the message clusters.

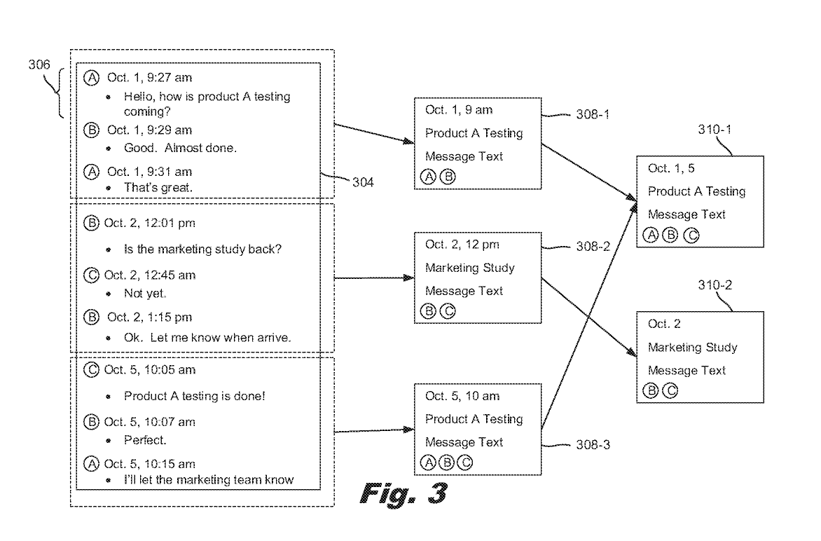

FIG. 3 depicts various levels of message grouping based on temporal and multi-feature similarity, according to an example of the principles described herein. As described above, a group messaging system includes a conversation (304) that includes a number of messages (306). For simplicity, a single message (306) is indicated with a reference number in FIG. 3.

Each message (306) may include various pieces of information. For example, a message (306) may indicate an author of the message (306), the text of the message (306), as well as a time when the message (306) was sent. For example, a first message time-stamped October 1^{st}, at 9:27 am was sent by User A, with the text “Hello, how is product A testing coming?” As described above, a burst grouper (FIG. 2, 206) groups these messages (306) into message bursts (308) based on any number of criteria. For example, the first three messages (306) may be grouped into a first message burst (308-1) based on the inter-message interval of each message (306) being less than a predetermined amount, for example 1 hour. Similarly, the second three messages (306) may be grouped into a second message burst (308-2) because they as well have inter-message intervals of less than the predetermined threshold but boundary messages within that second message burst (308-2) have inter-message intervals greater than the predetermined threshold. Still further, the last three messages (306) may be grouped into a third message burst (308-3) because they as well have inter-message intervals of less than the predetermined threshold but boundary messages within that third message burst (308-3) have inter-message intervals greater than the predetermined threshold.

In some examples, a user interface may switch between presenting the messages as a conversation (304) and as message bursts (308) based on a user action. For example, a user may click on an icon, perform a multi-touch function on a touch-sensitive display, or otherwise perform some physical input, or vocal input that switches a display screen from a message mode to burst mode.

Each message burst (308) may include various pieces of information. For example, the message burst (308) may indicate a time frame over which the message burst (308) occurred. The message burst (308) may also include a topic, or summarization of the message burst (308). For example, the first message burst (308-1) has a topic of “Product A Testing,” the second message burst (308-2) has a topic of “Marketing Study,” and the third message burst (308-3) has a topic of “Product A Testing.” Each message burst (308) may also include icons, or other indication, of the users who have participated in that particular message burst (308) as well as a snippet and/or link to the messages (306) within that message burst (308). Note that the message bursts (308) are chronologically-organized, meaning that each message burst (308) is sequential to the next one displayed.

Multiple of the message bursts (308) can then be grouped into message clusters (310-1, 310-2). As described above, the grouping of the message bursts (308) into a message cluster (310) is not only temporal, but is based on other features. For example, the two message bursts (308-1, 308-3) that are related to “Product A Testing” may be grouped into a first message cluster (310-1), notwithstanding their disjointed nature within the original conversation (304). As with the message bursts (308), each message cluster (310) may include various pieces of information including the relevant dates, summaries, snippets and/or links to message text as well as participants in the message cluster (310).

In some examples, a user interface may switch between presenting the messages as message bursts (308) and as message clusters (310) based on a user action. For example, a user may click on an icon, perform a multi-touch function on a touch-sensitive display, or otherwise perform some physical input, or vocal input that switches a display screen from a burst mode to cluster mode. As described above, such grouping may continue such that each message cluster (310) is grouped into a second-degree message cluster, for example relating in general to Product A.

In this example, further user action may be carried out to perform different display functions. For example, a user may select the first message cluster (310-1) to return to a burst mode, albeit with different message bursts (308) displayed. That is, selection of the first message cluster (310-1) may display a revised set of message bursts (308) that includes the message bursts (308-1, 308-3) relating to “Product A Testing” but may filter the “Marketing Study” message burst (308-2). In other words, by performing a user action within a message cluster (310), the message bursts (308) displayed are no longer displayed chronologically. Thus, the present system provides a robust way for a user to zoom in and out of a conversation (304) to explore the topics at different levels of generality, with a zoom-in feature being independent of the zoom-out feature.

In some examples, in addition to displaying the messages (306), message bursts (308), or message clusters (310), a timeline may show how the selected message bursts (308) and/or message clusters (310) are distributed over time. Different colors may be used in the timeline to denote message bursts (308) in different conversations (304) or teams.

FIG. 4 depicts a flowchart of a method (400) for grouping messages (FIG. 3, 306) based on temporal and multi-feature similarity, according to an example of principles described herein. According to the example, multiple messages (FIG. 3, 306) of a corpus are grouped (block 401) into a number of message bursts (FIG. 3, 308). In some examples, a topic, or list of topics can be determined (block 402) for each of the message bursts (FIG. 3, 308). That is, each message burst may be summarized, and a topic generated for that message burst. This may be done using any number of message summarization operations. For example, a key message may be identified, and that message classified as the topic. In another example, extraneous terms may be removed from the key message, or a few messages and the messages with extraneous terms removed may be classified as the topic for that message burst. As a specific example, a keyword extraction operation can be used to generate a set of keywords, entities or a category within a taxonomy structure. In another example, an operation can determine a topic for the message burst and then generate a label for the topic from the dominant words in a topic as a whole. In another example, statistical operations can look for uncommon and/or potentially interesting words or phrases within a message burst relative to a team, channel, or other messages visible to a user. While specific examples are provided of burst summarization, other examples are possible as well.

Then, responsive to a first user action, the number of message bursts (FIG. 3, 308) are presented (block 403). For example, a user may execute a reverse-pinch motion, scroll a mouse wheel, or click on an icon. In so doing, the display of a user computing device switches from a message mode, that displays all messages (FIG. 3, 306) to a burst mode that displays the message bursts (FIG. 3, 308). While particular reference is made to particular user actions, other user actions may trigger the presentation of the message bursts (FIG. 3, 308) as described above.

According to the method (400), each message burst (FIG. 3, 308) is then converted (block 404) into a feature vector. A feature vector is a mathematical representation of characteristics of the message burst (FIG. 3, 308). For example, a 2-dimensional feature vector may have an x-component and a y-component, the x-component reflecting a time value and the y-component reflecting a user-participation component for a particular user. These two components when taken together can define a message burst (FIG. 3, 308). While specific reference is made to a 2-dimensional feature vector, any n-dimensional feature vector may be constructed, with the dimensions referring to the different features used to define a particular message burst (FIG. 3, 308) and to compare it to other feature vectors. In other words, a feature vector is a pointer in n-dimensional space with an angle and length which angle and length can be used to gauge similarity between feature vectors associated with other message bursts (FIG. 3, 308).

In some examples, each user may be represented as a different feature. In some examples, the existence of certain words, terms, concepts or topics may also be treated as a feature. In one specific example, each such feature is vectorized by treating the feature as a single dimension and the existence or non-existence of the feature in the message burst (FIG. 3, 308) or message cluster (FIG. 3, 310) being treated as a value of 1 or 0 with respect to that dimension, or the number may be used to represent a frequency of the feature in the message burst (FIG. 3, 308) or message cluster (FIG. 3, 310). The vectorization may include features that are represented in multiple dimensions, a process referred to as embedding. For instance, words or paragraphs of text may be embedded in a feature space

Accordingly, message bursts (FIG. 3, 308) whose feature vectors have a predetermined degree of similarity are grouped (block 405) into a message cluster (FIG. 3, 310). An example of a predetermined degree of similarity and determining whether two feature vectors fall within that predetermined degree is presented below in connection with FIG. 6.

Then, responsive to a second user action, the number of message clusters (FIG. 3, 310) are presented (block 406). For example, a user may execute a reverse-pinch motion, scroll a mouse wheel, or click on an icon. In so doing, the display of a user computing device switches from a burst mode, that displays all message bursts (FIG. 3, 308) to a cluster mode that displays the message clusters (FIG. 3, 310). While particular reference is made to particular user actions, other user actions may trigger the presentation of the message clusters (FIG. 3, 308) as described above.

As described above, the method (400) provides a recursive process to allow a user to continue to “zoom out” and view the messages (FIG. 3, 306) grouped at any level of generality. Accordingly, the operations described in blocks 407-412 could be repeated for different grouping elements. In this example, a grouping element includes a message burst (FIG. 3, 308), a message cluster (FIG. 3, 310), a second-degree message cluster, and additional levels of hierarchical grouping elements. For example, it is determined (block 407) whether a zoom out motion is executed. If a zoom out motion is executed (block 407, determination YES), similar to the message bursts (FIG. 3, 308), an element, such as a message cluster (FIG. 3, 310) can be converted (block 408) into a feature vector and grouped (block 409) with other elements, e.g., message clusters (FIG. 3, 310) having feature vectors with a predetermined degree of similarity. As described above, the threshold of similarity used to group message clusters (FIG. 3, 310) may be different, and more inclusive, than the degree of similarity used to group message bursts (FIG. 3, 308). Then, the number of grouped elements, second-degree message clusters in this example, are presented (block 410). For example, a user may execute a reverse-pinch motion, scroll a mouse wheel, or click on an icon. In so doing, the display of a user computing device switches from a cluster mode, that displays all message clusters (FIG. 3, 310) to a second-degree cluster mode that displays the second-degree message clusters. While particular reference is made to particular user actions, other user actions may trigger the presentation of the message clusters (FIG. 3, 308) as described above. The above steps can be reiterated to continue to “zoom out” on a particular conversation to visualize the information at greater degrees of generality. For example, if a second zoom out motion is executed, the element, in this case a second-degree message cluster is converted (block 408) into a feature vector, grouped (block 409) with others), and presented (block 410) along with those it is grouped with. Accordingly, as can be seen, any number of “zoom out” motions can allow a user to increasingly expand the categorization of the different messages (FIG. 3, 306) for viewing at any level of generality.

At any point, if a zoom out motion is not executed (block 407, determination NO), it is determined if an element action is executed (block 411). In this example, an element action refers to a user action, such as a click, within the message element such as a message cluster (FIG. 3, 310) and a second-degree message cluster among others. In some examples, the user action may be a “zoom in” action.” If a zoom in action is not executed (block 411, determination NO) no further operations are executed. If a zoom in action is executed (block 411, determination YES), the components within the message element, i.e., message cluster (FIG. 3, 310) or second-degree message cluster, are presented (block 412). For example, if a user clicks on a particular message cluster (FIG. 3, 310) the contents of that message cluster (FIG. 3, 310) are presented, i.e., the message bursts (FIG. 3, 308) are displayed. Such an action can be carried out for second-degree message clusters as well. For example, after the number of second-degree message clusters are presented (block 410), a user may click on a second-degree message cluster to display the message clusters (FIG. 3, 310) therein. Once the components therein are presented (block 412), it is then again determined (block 407) whether a zoom out action is executed.

Accordingly, such a system provides for robust navigation of a corpus of messages (FIG. 3, 306), which may be rather large. Such navigation may start out chronologically, but shift to topically once a user selects to group message bursts (FIG. 3, 308) into message clusters (FIG. 3, 310).

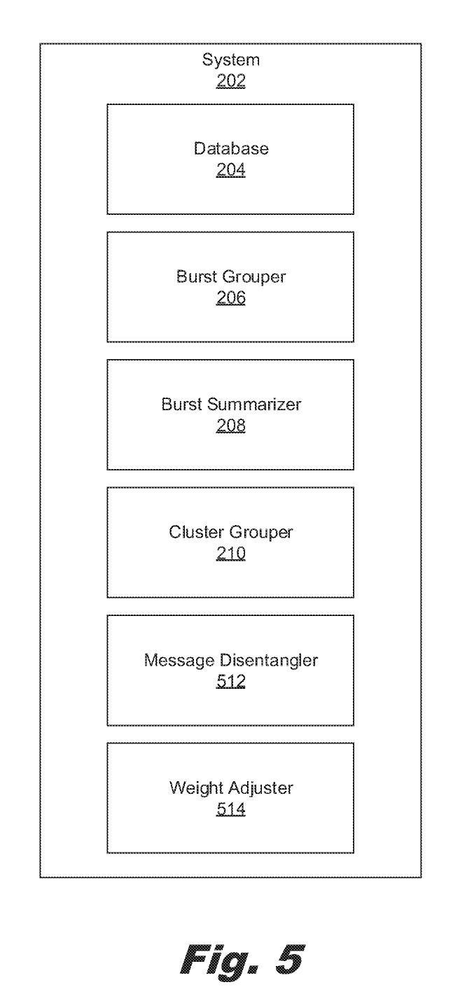

FIG. 5 depicts a system (202) for grouping messages (FIG. 3, 306) based on temporal and multi-feature similarity, according to an example of the principles described herein. The system (202) may include the database (204), burst grouper (206), burst summarizer (208), and cluster grouper (210) similar to those described above in regards to FIG. 2. In some examples, the system further includes a message disentangler (512) that separates multiple interleaved threads which occur concurrently in a single threaded conversation (FIG. 3, 304). That is, the message distentangler (512) creates message bursts (FIG. 3, 308) which are not fully continuous.

The system (202) may also include a weight adjuster (514) that facilitates user adjustment of the weights applied to the features used to determine similarity. For example, a user interface may present the user with sliders corresponding to the different features and the user may slide the sliders to increase or decrease the weight of a particular feature. For example, a user may reduce a slider corresponding to “temporal proximity” to reduce the weight that closeness of message bursts (FIG. 3, 308) have in determining whether to group message bursts (FIG. 3, 308). While sliders are mentioned, any other time of visual indication may be used by the weight adjuster (514) to receive the user input.

FIG. 6 depicts a graph of feature vector (612) similarity, according to an example of the principles described herein. As described above, each message burst (FIG. 3, 308) or message cluster (FIG. 3, 310) can be presented as a feature vector (612) which is an n-dimensional pointer based on a variety of features. In other words, particular aspects of a conversation can be vectorized. For simplicity, the feature vectors (612) described in FIG. 6 are 2-dimensional feature vectors (612). Specifically, a first feature vector (612-1) represents a first message burst (FIG. 3, 308), a second feature vector (612-2) represents a second message burst (FIG. 3, 308), and a third feature vector (612-3) represents a third message burst (FIG. 3, 308). The first and second feature vectors (612-1, 612-2) represent message bursts (FIG. 3, 308) with roughly the same amount of participation from a particular user and are similar in one fashion. By comparison, the second and third feature vectors (612-2, 612-3) represent message bursts (FIG. 3, 308) from roughly the same period of time and so are similar in another way.

In this specific example, participation can be vectorized in a number of ways. First, it could have binary values depending on whether that person participated. In another example, participation could be based on a scale indicating a degree of participation and this participation could be scaled relative to the total participation in the moment. Accordingly, values may have a particular range like 0-1 or 0-100.

Once the different message bursts (FIG. 3, 308) and/or message clusters (FIG. 3, 310) have been vectorized, adjacent message bursts (FIG. 3, 308) or message clusters (FIG. 3, 310) can be analyzed. For example, using a Euclidean distance, indicated by the circles in FIG. 6, the first feature vector (612-1) and the third feature vector (612-3) are both neighbors to the second feature vector (612-2), but given the first feature vector (612-1), only the second feature vector (612-2) would be analyzed as a neighbor. In another example, to determine whether neighbors are sufficiently similar to be grouped together, the angle between the feature vectors and relative magnitude could be compared to some threshold angle and magnitude difference. If sufficiently similar, the message bursts (FIG. 3, 308) and/or message clusters (FIG. 3, 310) can be grouped into a message cluster (FIG. 3, 310) or second-degree cluster respectively.

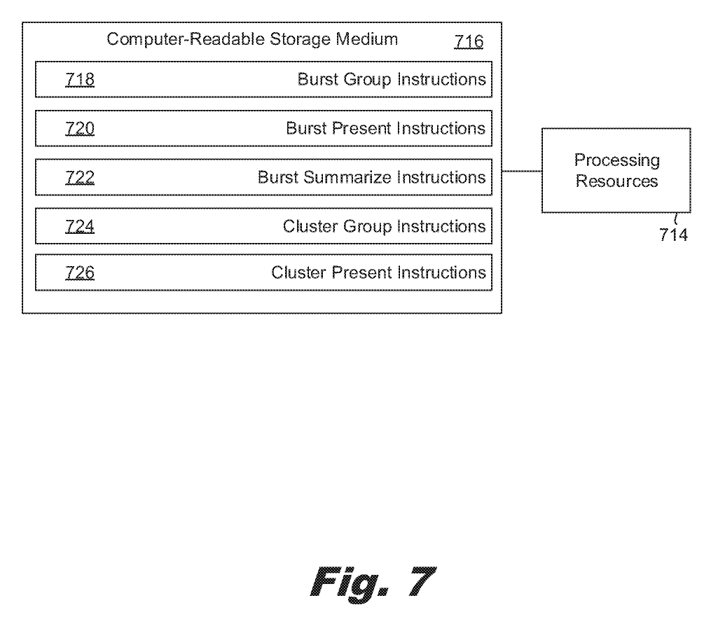

FIG. 7 depicts a computer readable storage medium (716) for grouping messages (FIG. 3, 308) based on temporal and multi-feature similarity, according to an example of principles described herein. To achieve its desired functionality, a computing system includes various hardware components. Specifically, a computing system includes processing resource (714) and a computer-readable storage medium (716). The computer-readable storage medium (716) is communicatively coupled to the processing resource (714). The computer-readable storage medium (716) includes a number of instructions (718, 720, 722, 724, 726) for performing a designated function. The computer-readable storage medium (716) causes the processing resource (714) to execute the designated function of the instructions (718, 720, 722, 724, 726).

Referring to FIG. 7, burst group instructions (718), when executed by the processing resources, cause the processor (714) to group multiple messages (FIG. 3, 306) of a corpus in a group messaging system into a number of message bursts (FIG. 3, 308). In this example each message burst (FIG. 3, 308) includes a number of messages (FIG. 3, 306) that have a temporal relationship. Burst present instructions (720), when executed by the processor (714), may cause the processor (714) to present the number of message bursts (FIG. 3, 308) responsive to a first user action. Burst summarize instructions (722), when executed by the processor (714), may cause the processor (714) to determine a topic, or list of topics, for each of the number of message bursts (FIG. 3, 308). Cluster group instructions (724), when executed by the processor (714), may cause the processor (714) to group multiple of the number of message bursts (FIG. 3, 308) into a message cluster (FIG. 3, 310). Cluster present instructions (726), when executed by the processor (714), may cause the processor (714) to present a number of message clusters (FIG. 3, 310) responsive to a second user action. In some examples, the program instructions are provided as a service in a cloud environment.

In summary, such a system and method 1) allow a user to gain contextual information about a topic, whether or not the user was there; 2) allow a user to view topical conversations in which they may not have participated, but are related to a topic of interest; 3) allow a user to understand a larger context of a given conversation, including related decisions already made and things learned; 4) group messages not only temporally, but topically; 5) provide efficient navigation of a corpus of messages based on topic; 6) provide viewing of information to any level of generality; and 7) provide a robust organization of conversation messages. However, it is contemplated that the devices disclosed herein may address other matters and deficiencies in a number of technical areas.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
grouping multiple messages of a corpus in a group messaging system into a number of message bursts, wherein each message burst comprises a number of messages that have a temporal relationship; and
grouping multiple of the number of messages bursts into a message cluster, which grouping is based on a similarity of the number of message bursts as defined by multiple features of the message bursts.

2. The computer-implemented method of claim 1, further comprising:
responsive to a first user action, presenting the number of message bursts; and
responsive to a second user action, presenting a number of message clusters.

3. The computer-implemented method of claim 1, further comprising responsive to a third user action within the message cluster, presenting the message bursts within the message cluster.

4. The computer-implemented method of claim 1, wherein grouping multiple of the number of message bursts into a message cluster comprises:
converting each message burst into a feature vector; and
grouping together message bursts whose feature vectors have a predetermined degree of similarity.

5. The computer-implemented method of claim 1, wherein the multiple features comprise user-specific features unique to a particular user.

6. The computer-implemented method of claim 1, wherein the multiple features of the message bursts comprise weighted features.

7. The computer-implemented method of claim 6, wherein a weight of a weighted feature is selected based on at least one of a user behavior, a group behavior, and an entity behavior.

8. The computer-implemented method of claim 1, wherein grouping multiple messages of a corpus into a number of message bursts comprises grouping the multiple messages based on an inter-message interval time.

9. The computer-implemented method of claim 1, wherein grouping multiple messages of a corpus into a number of message bursts comprises grouping the multiple messages based on at least one of:
natural language processing of valediction, salutation, and connecting words; and
topical analysis.

10. A system comprising:
a database to contain a corpus of messages for a group messaging system;
a burst grouper to group multiple messages of the corpus into a number of message bursts, wherein each message burst comprises a number of messages that have a temporal relationship;
a burst summarizer to determine at least one topic for each of the number of message bursts;
a cluster grouper to group multiple of the number of message bursts into a message cluster, which grouping is based on a similarity of the number of message bursts as defined by multiple features of the message bursts.

11. The system of claim 10, further comprising a disentanglement engine to disentangle the multiple messages of the corpus.

12. The system of claim 10, wherein:
a message burst comprises messages that have a temporal similarity; and
a message cluster comprises message bursts that have a topical similarity and are disjointed in time.

13. The system of claim 10, wherein the cluster grouper groups multiple message clusters into a second-degree message cluster based on a similarity of the multiple message clusters as defined by multiple features of the message clusters.

14. The system of claim 13, wherein:
the cluster grouper uses a first similarity threshold to group multiple of the number of message bursts into a message cluster;
the cluster grouper uses a second similarity threshold to group multiple message clusters into a second-degree message cluster; and
the second similarity threshold is more inclusive than the first similarity threshold.

15. The system of claim 13, wherein grouping multiple message clusters into a second-degree message cluster comprises:
converting each message cluster into a feature vector; and
grouping together message clusters whose feature vectors have a predetermined degree of similarity.

16. The system of claim 13, wherein:
the features of the message bursts used to group multiple message bursts into a message cluster are weighted according to a first scheme;
the features of the message clusters used to group multiple message clusters into a second-degree message cluster are weighted according to a second scheme; and
wherein the first scheme and second scheme are different from one another.

17. The system of claim 10, further comprising a weight engine to adjust weights of the multiple features used to group message bursts into a message cluster.

18. The system of claim 10, wherein the multiple messages of the corpus that form a message burst are from different conversations within the group messaging system.

19. A computer program product, the computer program product comprising a computer readable storage medium having program instructions embodied therewith, the program instructions executable by a processor to cause the processor to:
group, by the processor, multiple messages of a corpus in a group messaging system into a number of message bursts, wherein each message burst comprises a number of messages that have a temporal relationship;
present, by the processor, the number of message bursts responsive to a first user action;
determine, by the processor, at least one topic for each of the number of message bursts;
group, by the processor, multiple of the number of messages bursts into a message cluster, wherein:
the grouping is based on a similarity of the number of message bursts as defined by multiple features of the message bursts; and
the number of message bursts comprise at least two message bursts that are disjointed in time; and
present, by the processor, a number of message clusters responsive to a second user action.

20. The computer program product of claim 19, wherein the multiple features comprise features selected from the group consisting of:
participants in the conversation;
level of participation of the user;
keywords;
entities; and
classification of the message burst.
